(19) United States
(12) Patent Application Publication
(10) Pub. No.: US 2010/0286953 A1
(43) Pub. Date: Nov. 11, 2010

(54) PATH LOSS CALCULATION METHOD USING REFLECTION PATH AS DOMINANT PATH

(75) Inventors: Jongho Kim, Daejon (KR); Heonjin Hong, Daejon (KR); Chang-Joo Kim, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejon (KR)

(21) Appl. No.: 12/746,424

(22) PCT Filed: Jun. 27, 2008
(86) PCT No.: PCT/KR2008/003734

§ 371 Date: Jun. 4, 2010

(30) Foreign Application Priority Data
Dec. 5, 2007 (KR) 10-2007-0125606

(51) Int. Cl. G06F 17/18

(52) U.S. Cl. 702/179

(57) ABSTRACT

Provided is a method for calculating a path loss using reflection paths as dominant paths. The method includes determining a reflection plane and a reflection point in case of reflection; calculating electric field strength for the determined reflection plane and reflection point; calculating electric field strength based on a statistical loss value by diffraction according to a propagation environment in case of diffraction; and calculating a path loss based on the calculated electric field strength for reflection and the calculated electric field strength for diffraction.

### TECHNICAL FIELD

The present invention relates to a path loss calculation method using a reflection path as a dominant path; and, more particularly, to a path loss calculation method which can predict propagation more exactly than a propagation model of a statistical method and much faster than a propagation model of a theoretical method.

This work was supported by the IT R&D program for MIC/IITA [2005-S-046-03, “Development of the basic spectrum resource utilizing technology”].

### BACKGROUND ART

A propagation model is required to predict path loss occurring due to diverse radio propagation appearing while the propagation is transmitted through a space. The propagation model includes a statistical model acquired based on a measurement result and a theoretical model based on a propagation theory.

Since the propagation model is exposed to diverse environments, massive measurement in diverse situations is required to acquire a statistical variable. The propagation model of the statistical method is a method for forming a model equation by classifying the environments and dividing frequency bands based on the measured information. In the propagation model of the statistical method, although a procedure of creating a model is complicated and difficult, model equation is simple and calculation is fast. However, the propagation model of the statistical method has shortcomings that the frequency is limited and exactness is very low. Therefore, the propagation model of the statistical method is applied to coverage analysis having a broadcasting field or a macro cell as a target.

In the propagation model of the theoretical method, the calculation equation is complicated and time required for calculation is consumed a lot. However, there are merits that exactness is very high and the frequency is not limited.

As the propagation model of the theoretical method, a ray tracing method is a method for searching all rays capable of reaching from a transmission antenna to a reception antenna and summating and showing each size of the rays.

The ray tracing method can exactly predict the path loss. However, the ray tracing method has a shortcoming that the calculation time required for prediction is consumed a lot. Since it is recently possible to reduce the calculation time in the limited region due to extension of computing capacity and continuous research, the ray tracing method is generally used. However, the ray tracing method still has a shortcoming that the calculation time is consumed a lot in a complicated environment where a transmission/reception distance is far or there are many obstacles.

A dominant path model capable of overcoming the shortcoming of the ray tracing method and improving exactness is suggested. The dominant path model divides a propagation path into a reflected path and a diffracted path. The dominant path model applies the statistical method to the reflected path and processes the reflected path as a representative loss value according to environment classification. The dominant path model applies the ray tracing method to the diffracted path and calculates the strength of the signal arriving at a receiver by tracing the diffracted path of the propagation. The dominant path model is much faster than the conventional ray tracing method in the calculation time and is similar to the conventional ray tracing method in exactness. In a dead zone in a long distance, the dominant path model can have more exact result than the ray tracing method.

A method for improving a calculation speed and exactness based on the conventional propagation model is required.

### DISCLOSURE OF INVENTION

### Technical Problem

An embodiment of the present invention is directed to providing a method for calculating a path loss using reflection paths as dominant paths which can reduce a calculation time and exactly predict propagation by calculating electric field strength in a reflection node by determining a reflection plane and a reflection point according to a ray tracing method and calculating electric field strength on diffraction based on a statistical loss value by diffraction of each propagation environment.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for calculating a path loss for a propagation environment, including: determining a reflection plane and a reflection point in case of reflection; calculating electric field strength for the determined reflection plane and reflection point; calculating electric field strength based on a statistical loss value by diffraction according to a propagation environment in case of diffraction; and calculating a path loss based on the calculated electric field strength for reflection and the calculated electric field strength for diffraction.

In accordance with another aspect of the present invention, there is provided a method for calculating a path loss for a propagation environment, including: determining a transmission point and a reception point and starting to trace a propagation path according to a ray tracing method; determining a reflection plane and a reflection point in case of reflection and calculating electric field strength of the determined reflection plane and reflection point; calculating electric field strength based on a statistical loss value by diffraction according to a propagation environment in case of diffraction; and when the cross point can be directly connected to the reception point, a path loss is calculated based on the calculated electric field strength for reflection and the calculated electric field strength for diffraction.

### ADVANTAGEOUS EFFECTS

The present invention calculates electric field strength in a reflection node by determining a reflection plane and a reflection point according to a ray tracing method and calculates electric field strength on diffraction based on a statistical loss value by diffraction of each propagation environment. Accordingly, the present invention can reduce a calculation time by searching a diffraction point consuming a lot of time when a path loss is calculated in the ray tracing method and omitting a procedure of calculating the loss by diffraction. Compared with the conventional propagation model by the dominant path, the present invention can improve exactness by tracing and calculating a reflection path, which is comparatively important.

### BRIEF DESCRIPTION OF THE DRAWINGS

FIG. 1 is a flowchart describing a path loss calculating procedure according to a conventional ray tracing method.

FIG. 2 is a flowchart describing a path loss calculation method using a dominant path model suggested to solve the problem of the conventional ray tracing method.

FIG. 3 is a flowchart describing the path loss calculation method in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. Therefore, those skilled in the art of the present invention can embody the technological concept and scope of the invention easily. In addition, if it is considered that detailed description on a related art may obscure the points of the present invention, the detailed description will not be provided herein. Specific embodiments of the present invention will be described in detail hereinafter with reference to the attached drawings.

When propagation progresses in space, reflection or diffraction occurs by an obstacle. Generally, strength of a reflected signal is larger than that of a diffracted signal. That is, a loss is smaller in the reflected signal than the diffracted signal. The conventional dominant path model can maintain exactness and reduce a calculation time by processing the reflected signals statistically and processing the diffracted signals according to a ray tracing method. However, the present invention processes the reflected signals according to the ray tracing method and statistically processes the diffracted signals. Accordingly, since the present invention can improve entire propagation prediction exactness by exactly processing stronger reflected signals than the conventional dominant path model and maintain the calculation time similarly to the conventional dominant path model by statistically processing weak diffracted signals.

When there are transmission/reception points on space, a plurality of paths of the propagation progressing among the transmission/reception points are generated by neighboring obstacles and the propagations passing through each path are converged at the reception point.

There are direct wave, reflection wave and diffraction wave according to radio propagation appearing when the propagation passes through each path. The loss on entire paths by the direct wave, the reflection wave and the diffraction wave is expresses as shown in Equation 1.

L=L_{free}(f,d_{free})+ΣL_{reflection}(α,dᵣ)+ΣL_{diffraction}(δ,d_{d}) Eq. 1

In Equation 1, L_{free}(f,d_{free}) is a loss by the free space and is a function by frequency (f) and free space distance (d_{free}).

ΣL_{reflection}(α,dᵣ)

is a loss by the reflection path and is a function by reflection angle (α) and reflection distance (dᵣ).

ΣL_{diffraction}(δ,d_{d})

is a loss by the diffracted path is a function by diffraction angle (δ) and diffraction distance (d_{d}).

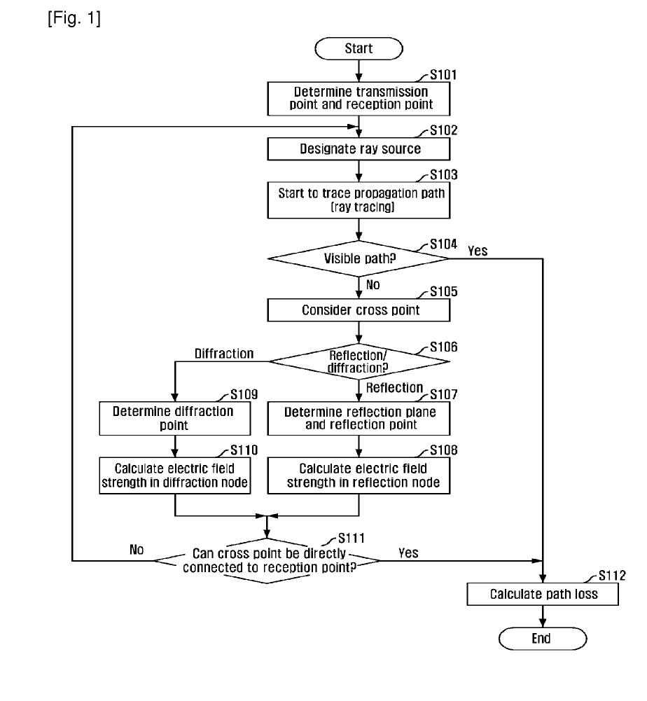

The ray tracing method is a method for searching all paths, calculating the loss of each path, and converging all paths into a reception point. FIG. 1 is a flowchart describing a path loss calculating procedure according to the conventional ray tracing method.

Referring to FIG. 1, transmission point and reception point are determined at step S101 and a ray source is designated at step S102. It is started to trace a propagation path at step S103. When the propagation path is not a visible path at step S104, a cross point is considered at step S105. In case of reflection at step S106, electric field strength is calculated in the reflection node at step 5108 after determining a reflection plane and a reflection point at step S107.

In case of diffraction at step S106, a diffraction point is determined at step S109 and the electric field strength is calculated in the diffraction node at step S110. Subsequently, it is checked at step S111 whether the cross point can be directly connected to the reception point. When the cross point cannot be directly connected to the reception point, a logic flow goes back to the step S102 of designating a ray source. However, when the cross point can be directly connected to the reception point at the step S111, the path loss is calculated at step S112. In the visible path, the path loss is directly calculated at step S112.

Although the conventional ray tracing method secures exactness through calculation based on a theoretical background, a lot of calculation time is required in the procedure of determining a diffraction point for all rays or determining a reflection plane and a reflection point.

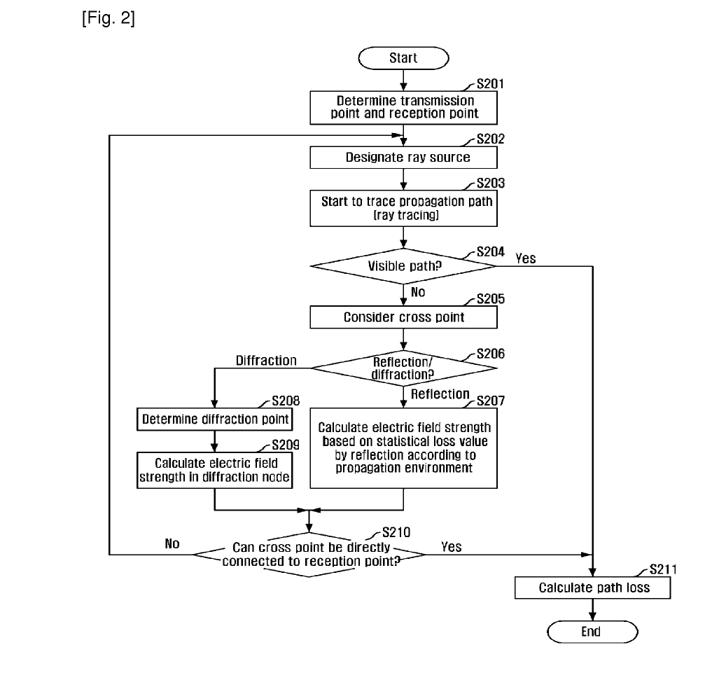

FIG. 2 is a flowchart describing a path loss calculation method using a dominant path model suggested to solve the problem of the conventional ray tracing method.

Referring to FIG. 2, a transmission point and a reception point are determined at step S201 and a ray source is designated at step S202. Subsequently, it is started to trace a propagation path at step S203. When the propagation path is not a visible path at step S204, a cross point is considered at step S205. In case of reflection at step S206, electric field strength is calculated at step S207 based on a statistical loss value by reflection according to the propagation environment.

In diffraction, a diffraction point is determined at step S208 and electric field strength is calculated in a diffraction node at step S209. Subsequently, it is checked at step S210 whether the cross point can be directly connected to the reception point. When the cross point cannot be directly connected to the reception point, a logic flow goes back to the step S202 of designating the ray source. However, when the cross point can be directly connected to the reception point at step S210, a path loss is calculated at step S211. In the visible path, the path loss is directly calculated at step S211.

As described above, the method using the conventional dominant path model calculates electric field strength based on the statistical loss value by the reflection according to the propagation environment and uses the conventional ray tracing method for the diffraction point instead of the procedure of determining the reflection plane and the reflection point which is one of parts consuming the longest calculation time in the ray tracing method. Accordingly, since the method using the conventional dominant path model does not require the time for determining the reflection plane and the reflection point, it is possible to remarkably reduce the entire calculation time.

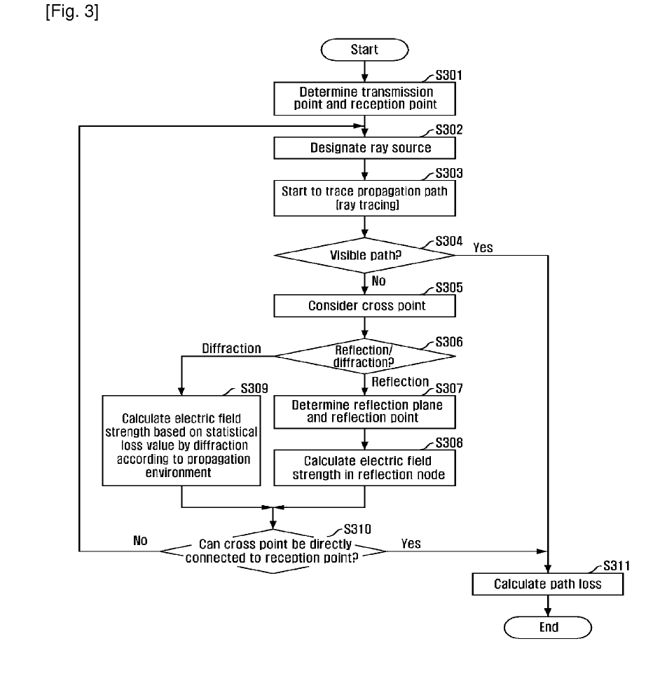

FIG. 3 is a flowchart describing a path loss calculation method in accordance with an embodiment of the present invention.

Referring to FIG. 3, the transmission point and the reception point are determined at step S301 and a ray source is designated at step S302. Subsequently, it is started to trace a propagation path at step S303. When the propagation path is not a visible path at step S304, a cross point is considered at step S305. In case of reflection at step S306, electric field strength is calculated in a reflection node at step S308 after determining a reflection plane and a reflection point at step S307.

In case of diffraction at the step S306, electric field strength is calculated at step S309 based on a statistical loss value by diffraction according to the propagation environment. Subsequently, it is checked at step S310 whether the cross point can be directly connected to the reception point. When the cross point cannot be directly connected to the reception point, the logic flow goes back to the step S302. However, when the cross point can be directly connected to the reception point, a path loss is calculated at step S311 based on the calculated electric field strength for reflection and electric field strength for diffraction. In the visible path, the path loss is directly calculated at step S311.

As described above, the present invention processes the procedure of determining the reflection plane and the reflection point according to the ray tracing method and calculates the electric field strength based on the statistical loss value according to the propagation environment for the diffraction instead of the procedure of determining the diffraction point. In the present invention, the calculation time is reduced as much as the time for determining the diffraction point in comparison with the method of processing the diffraction point, the reflection plane and the reflection point according to the ray tracing method.

Accordingly, the process time of the present invention is similar to that of the conventional dominant path model. It is generally known as the path loss by diffraction is larger than the path loss by reflection. Also, since the present invention exactly calculates the signal by the reflection plane and the reflection point having large signal strength according to the ray tracing method, the present invention can improve exactness in comparison with the conventional dominant path model.

As described above, the technology of the present invention can be realized as a program. A code and a code segment forming the program can be easily inferred from a computer programmer of the related field. Also, the realized program is stored in a computer-readable recording medium, i.e., information storing media, and is read and operated by the computer, thereby realizing the method of the present invention. The recording medium includes all types of recording media which can be read by the computer.

The present application contains subject matter related to Korean Patent Application No. 2007-0125606, filed in the Korean Intellectual Property Office on Dec. 5, 2007, the entire contents of which are incorporated herein by reference.

While the present invention has been described with respect to certain preferred embodiments, it will be apparent to those skilled in the art that various changes and modifications may be made without departing from the scope of the invention as defined in the following claims.

1. A method for calculating a path loss for a propagation environment, comprising:
determining a reflection plane and a reflection point for reflection;
calculating electric field strength for the determined reflection plane and reflection point;
calculating electric field strength based on a statistical loss value by diffraction according to a propagation environment for diffraction; and
calculating a path loss based on the calculated electric field strength for reflection and the calculated electric field strength for diffraction.

2. The method of claim 1, wherein when the cross point is directly connected to the reception point, a path loss is calculated based the calculated electric field strength for reflection and the calculated electric field strength for diffraction.

3. The method of claim 2, further comprising:
starting to trace a propagation path according to a ray tracing method before determining the reflection plane and the reflection point for reflection.

4. The method of claim 3, wherein when the cross point is not directly connected to the reception point, said starting to trace a propagation path according to a ray tracing method is executed.

5. The method of claim 4, wherein after determining a transmission point and a reception point and designating a ray source, said starting to trace a propagation path according to a ray tracing method is executed.

6. The method of claim 4, wherein when the propagation path is a visible path, the path loss is calculated; and
when the propagation path is not the visible path, any one of said determining a reflection plane and a reflection point and said calculating electric field strength based on a statistical loss value is executed according to reflection or diffraction in consideration of the cross point.

7. A method for calculating a path loss for a propagation environment, comprising:
determining a transmission point and a reception point and starting to trace a propagation path according to a ray tracing method;
determining a reflection plane and a reflection point for reflection and calculating electric field strength of the determined reflection plane and reflection point;
calculating electric field strength based on a statistical loss value by diffraction according to a propagation environment for diffraction; and
when the cross point is directly connected to the reception point, calculating a path loss based on the calculated electric field strength for reflection and the calculated electric field strength for diffraction.

8. The method of claim 7, wherein said determining a transmission point and a reception point and starting to trace a propagation path includes:
determining the transmission point and the reception point and designating a ray source; and
starting to trace a propagation path according to a ray tracing method.

9. The method of claim 8, wherein when the cross point is directly connected to the reception point, said designating a ray source and subsequent process are repeated.

10. The method of claim 7, wherein after executing said determining a transmission point and a reception point and starting to trace a propagation path, when the propagation path is a visible path, said calculating a path loss is executed; and when the propagation path is not the visible path, any one of said determining a reflection plane and a reflection point for reflection and calculating electric field strength of the determined reflection plane and reflection point and said calculating electric field strength is executed.
